(19) United States
(12) Patent Application Publication
(10) Pub. No.: US 2016/0156035 A1
(43) Pub. Date: Jun. 2, 2016

(54) COMPOSITE MATERIAL, NEGATIVE ELECTRODE, AND SODIUM SECONDARY BATTERY

(71) Applicant: Industrial Technology Research Institute, Hsinchu (TW)

(72) Inventors: Tai-Feng HUNG, Taipei City (TW); Yu-Wen YEH, Xinfeng Township (TW); Wen-Sheng CHANG, Pingtung City (TW); Chang-Chung YANG, Taipei City (TW)

(73) Assignee: Industrial Technology Research Institute, Hsinchu (TW)

(21) Appl. No.: 14/584,595

(22) Filed: Dec. 29, 2014

(30) Foreign Application Priority Data
Nov. 27, 2014 (TW) 103141127

(51) Int. Cl. H01M 4/58; H01M 2/16; H01M 4/62; H01M 10/36; H01M 4/587; H01M 4/36

(52) U.S. Cl. CPC H01M 4/5825; H01M 4/587; H01M 4/364; H01M 4/622; H01M 4/625; H01M 10/36; H01M 4/58; H01M 2/1613; H01M 2/1626; H01M 2/1653; H01M 2004/027

(57) ABSTRACT

Disclosed is a composite material, having the chemical structure represented below: Na₁₊₍₄₋ₐ₎ₓTi₂₋ₓMₓ(PO₄)₃/C, wherein the M is an element with valence a, a is a positive integer from 1 to 4, and 0.1≦x≦0.4. The composite material can be mixed with an electrically conductive agent and a binder to form a negative electrode for application in a sodium secondary battery.

### CROSS REFERENCE TO RELATED APPLICATIONS

The present application is based on, and claims priority from, Taiwan Application Serial Number 103141127, filed on Nov. 27, 2014, the disclosure of which is hereby incorporated by reference herein in its entirety.

### TECHNICAL FIELD

The technical field relates to a composite material, and for a negative electrode in a sodium secondary battery.

### BACKGROUND

Because of rapid economic growth, petroleum source exhaustion, environmental pollution, and global warming, a novel energy system with high energy density that is environmentally saved and can be sustainably developed is necessary.

In recent years, secondary sodium batteries have attracted much attention in the field of chemical energy storage for the following reasons. (1) Sodium content is richer in earth crust (2.64%) than lithium content, and therefore its cost is much lower than lithium. (2) Sodium and lithium belong to the same group in the periodic table with several similar physical and chemical properties. In other words, sodium-ion batteries also have high working voltage and energy density. (3) Sodium-ion batteries can be classified to the organic type or the aqueous type, according to the polarity of the electrolyte solvent used in the battery. However, the sodium-ion battery with an organic type electrolyte still remains challenges in terms of cost, safety, and energy storage application. On contrary, the sodium-ion battery with an aqueous type electrolyte is suitable for a large electricity storage application due to its low cost and high safety.

A conventional sodium titanium phosphate/carbon composite (NaTi₂(PO₃)₄/C) has an operation voltage range suitable for the sodium-ion battery with the aqueous type electrolyte. However, the sodium titanium phosphate will be unstable after repeated charging and discharging, thereby decaying the capacity of the battery.

Accordingly, a stable composite material in a negative electrode for simultaneously enhancing the repetitive charge-discharge ability and the energy density of the battery is called for.

### SUMMARY

One embodiment of the disclosure provides a composite material, having the chemical formula: Na₁₊₍₄₋ₐ₎ₓTi₂₋ₓMₓ(PO₄)₃/C, wherein M is an element with valence a, a is positive integer from 1 to 4, and 0.1≦x≦0.4.

One embodiment of the disclosure provides a negative electrode, comprising: a conductive layer on an electrically conductive substrate, wherein the electrically conductive layer includes: 1 part by weight of the described composite material; 0.055 to 0.33 parts by weight of a binder, and 0.055 to 0.33 parts by weight of an electrically conductive agent.

One embodiment of the disclosure provides a sodium secondary battery, comprising: the described negative electrode; a positive electrode; a separator film disposed between the positive electrode and the negative electrode; and an electrolyte disposed between the positive electrode and the negative electrode.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 shows X-ray diffraction spectra of composite materials Na₁₊₂ₓTi₂₋ₓMgₓ(PO₄)₃/C (x=0-0.4) in one embodiment of the disclosure;

FIG. 2 shows X-ray diffraction spectra of composite materials Na₁₊ₓTi₂₋ₓAlₓ(PO₄)₃/C (x=0.1-0.4) in one embodiment of the disclosure;

FIG. 3 shows cycle life tests of batteries with negative electrodes including composite materials Na₁₊₂ₓTi₂₋ₓMgₓ(PO₄)₃/C (x=0 and 0.2) in one embodiment of the disclosure;

FIGS. 4A and 4B show discharge capacity and capacity retention of batteries with negative electrodes including composite materials Na₁₊₂ₓTi₂₋ₓMgₓ(PO₄)₃/C (x=0˜0.4) in one embodiment of the disclosure; and

FIG. 5 is a charge-discharge profile of a battery with a positive electrode (sodium-rich metal hexacyanoferrate) in one embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are shown schematically in order to simplify the drawing.

For improving the cycle stability of the conventional composite of sodium titanium phosphate and carbon material (NaTi₂(PO₄)₃/C), a composite material with high cycle stability is prepared by a sol-gel method and metal doping.

In one embodiment, the composite material Na₁₊₍₄₋ₐ₎ₓTi₂₋ₓMₓ(PO₄)₃/C is provided, wherein M is an element with valence a such as magnesium, aluminum, vanadium, chromium, manganese, cobalt, nickel, copper, zinc, or a combination thereof, a is a positive integer from 1 to 4, and 0.1≦x≦0.4. In one embodiment, the sodium titanium metal phosphate in the composite material has a Na⁺ superionic conductor (NASICON) structure. The doping ratio x will influence the lattice structure of the composite material. The composite material has a NASICON structure when x≦0.2. On the other hand, the composite will have another impurity phase and not a pure NASICON structure when x≧0.3.

In one embodiment, the composite material includes 90 wt % to 97 wt % of the sodium titanium metal phosphate and 10 wt % to 3 wt % of the carbon material, which is determined by thermogravimetric analysis.

In one embodiment, metal M is doped in the NaTi₂(PO₃)₄/C structure to form a stable bonding therein, thereby enhancing the repetitive charge-discharge ability of the composite material. The metal doping also reduces the over potential of the composite material Na₁₊₍₄₋ₐ₎ₓTi₂₋ₓMₓ(PO₄)₃/C during the charge/discharge procedures, thereby lengthening the cycle number of the battery with the negative electrode including the composite material. In other words, the problem such as conventional NaTi₂(PO₃)₄/C being unstable after repetitive charge/discharge can be avoided, thereby solving the battery problems such as capacity decay and poor cycle stability.

In one embodiment, the sodium precursor can be Na₂CO₃, CH₃COONa, NaOH, or a combination thereof. In one embodiment, the titanium precursor can be TiCl₄, Ti[OCH(CH₃)₂]₄, Ti(O₄H₉)₄, TiO₂, or a combination thereof. In one embodiment, the magnesium precursor can be Mg(NO₃)₂.6H₂O, MgCO₃, Mg(CH₃COO)₂, MgSO₄.7H₂O, or a combination thereof. In one embodiment, the phosphate precursor can be NH₄H₂PO₄, (NH₄)₂HPO₄, H₃PO₄, NaH₂PO₄, or a combination thereof.

In addition, one embodiment provides a negative electrode including an electrically conductive layer on an electrically conductive substrate, wherein the electrically conductive layer includes 1 part by weight of the above composite material; 0.055 to 0.33 parts by weight of a binder, and 0.055 to 0.33 parts by weight of an electrically conductive agent. An electrically conductive layer with an overly low amount of the binder is easily peeled from the electrically conductive substrate due to a poor adherence effect. An electrically conductive layer with an overly high amount of the binder will increase the resistance of the negative electrode and degrade the total electrical properties of the negative electrode. An overly low amount of the electrically conductive agent cannot help conducting the electrons, and the resistance of the negative electrode is therefore increased. An overly high amount of the electrically conductive agent will thicken the electrically conductive layer and lengthen the electron transfer path, and the resistance of the negative electrode is also increased. In one embodiment, the electrically conductive agent can be carbon black, graphite, carbon nanotube, carbon nanofiber, or a combination thereof. In one embodiment, the binder can be poly(tetrafluoroethylene) (PTFE), poly(vinylidene fluoride), (PVDF), polyvinyl alcohol (PVA), carboxymethylcellulose (CMC), styrene-butadiene rubber (SBR), or a combination thereof. In one embodiment, the electrically conductive substrate can be metal foil, metal mesh, metal foam, or a combination thereof of stainless steel, aluminum, copper, or nickel.

In another embodiment, a sodium secondary battery includes the above negative electrode, a positive electrode, a separator film disposed between the positive electrode and the negative electrode, and an electrolyte disposed between the positive electrode and the negative electrode. In one embodiment, the positive electrode can be sodium metal oxide (NaₓMO₂, M=Fe, Mn, Co, Ni, or a combination thereof, and 0<x≦1), sodium-rich metal hexacyanoferrate (Na₂MₓFe(CN)₆, M=Fe, Co, Ni, Cu, Zn, Mn, or a combination thereof, and 0<x≦1), sodium metal phosphate (Na₃M₂(PO₄)₃, M=Al or V), or a combination thereof. In one embodiment, the electrolyte can be organic type or aqueous type. The aqueous type electrolyte may contact the above positive and negative electrode materials, and the aqueous type electrolyte can be Na₂SO₄, NaCl, NaNO₃, or a combination thereof. The sodium-ion battery with the aqueous type electrolyte is suitable in large electricity storage application due to its low cost and high safety. In one embodiment, the separator disposed between the positive electrode and the negative electrode may avoid a short circuit between the positive and negative electrodes and allow ions penetrating therethrough. The separator film can be glass fiber film, paper filter, polypropylene film, polyethylene film, or a combination thereof.

Below, exemplary embodiments will be described in detail with reference to the accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Example 1

### Preparation of Composite Materials

Stoichiometric amounts of sodium precursor (CH₃COONa), titanium precursor (Ti[OCH(CH₃)₂]₄), magnesium precursor (Mg(NO₃)₂.6H₂O), and phosphate precursor (H₃PO₄) were weighed and mixed in 5 mL of water. Citric acid (1.5 times the moles of Na) served as a chelating agent and a carbon source was then added to the water to form an aqueous solution. The aqueous solution was ultrasonicated for 1 hour, and then left to stand for 12 hours to gel. The dried gel was put in a furnace under argon (flow rate of 300 mL/min), heated to and kept at 400° C. for 3 hours to be carbonized, and then heated to and kept at 750° C. for 10 hours to be sintered. The sintered material was then cooled at room temperature to obtain Na₁₊₂ₓTi₂₋ₓMgₓ(PO₄)₃/C (x=0-0.4), composite materials of Na⁺ superionic conductor.

### Example 2

Stoichiometric amounts of sodium precursor (CH₃COONa), titanium precursor (Ti[OCH(CH₃)₂]₄), aluminum precursor (Al(NO₃)₃.9H₂O), and phosphate precursor (H₃PO₄) were weighed and mixed in 5 mL of water. Citric acid (1.5 times the moles of Na) served as a chelating agent and a carbon source was then added to the water to form an aqueous solution. The aqueous solution was ultrasonicated for 1 hour, and then left to stand for 12 hours to gel. The dried gel was put in a furnace under argon (flow rate of 300 mL/min), heated to and kept at 400° C. for 3 hours to be carbonized, and then heated to and kept at 750° C. for 10 hours to be sintered. The sintered material was then cooled at room temperature to obtain Na₁₊ₓTi₂₋ₓAlₓ(PO₄)₃/C (x=0.1-0.4), composite materials of Na⁺ superionic conductor.

Structure Identification of the Composite Materials

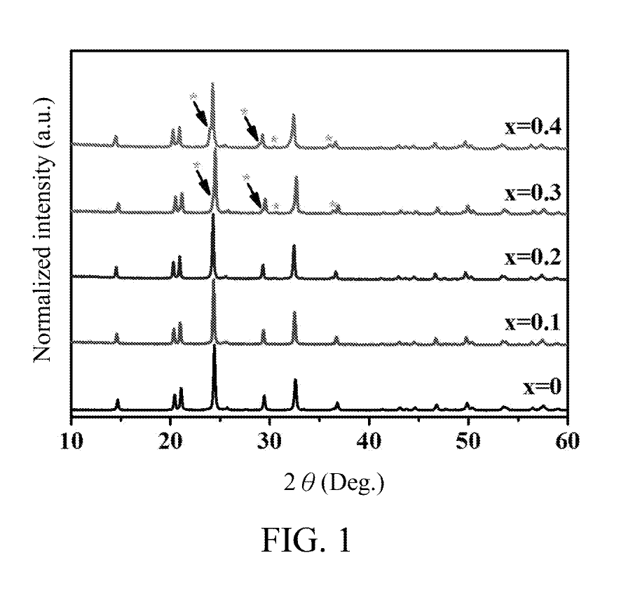

FIG. 1 shows X-ray diffraction spectra of the composite materials Na₁₊₂ₓTi₂₋ₓMgₓ(PO₄)₃/C (x=0-0.4) in Example 1, which were identified by Bruker-D2 Phaser. As shown in FIG. 1, the composites had high crystallinity and pure phase when x≦0.2. The X-ray diffraction spectra show that the composite included an impurity phase of Na_{0.9}Mg_{0.45}Ti_{3.55}O when x≧0.3.

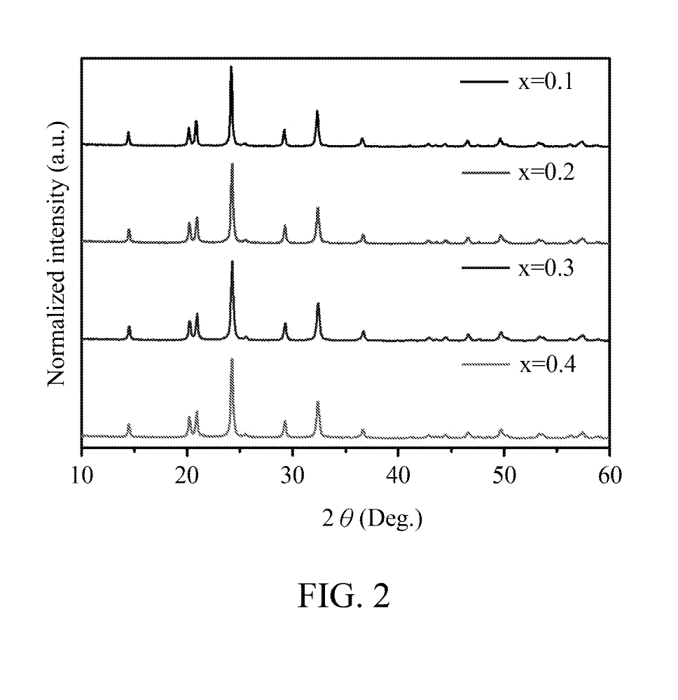

FIG. 2 shows X-ray diffraction spectra of the composite materials Na₁₊ₓTi₂₋ₓAlₓ(PO₄)₃/C in Example 2, which were identified by Bruker-D2 Phaser. As shown in FIG. 2, the composites had high crystallinity and pure phase without any other impurity phase when x=0.1˜0.4.

Preparation of Electrodes

First, N-methyl-2-pyrrolodone (NMP) was selected as a solvent. 1 part by weight of the composite materials Na₁₊₂ₓTi₂₋ₓMgₓ(PO₄)₃/C (x=0-0.4) in Example 1, 0.257 parts by weight of electrically conductive agent (Super-P or KS6), and 0.171 parts by weight of binder (PVDF) were mixed in the solvent. The mixture was then coated on a stainless mesh, dried at 90° C., and calendered by a calendering machine to obtain the negative electrode of the disclosure.

Preparation of Batteries

Sodium manganese oxide or sodium-rich metal hexacyanoferrate was selected as a positive electrode. The polypropylene after hydrophilic treatment was selected as a separator film. 1M sodium sulfate aqueous solution was selected as an electrolyte. The positive electrode, the separator film, the negative electrode prepared as described above, and the electrolyte were sequentially put into a coin-type battery to assemble a sodium secondary battery.

### Example 3

### Test of Charge-Discharge Cycle Number

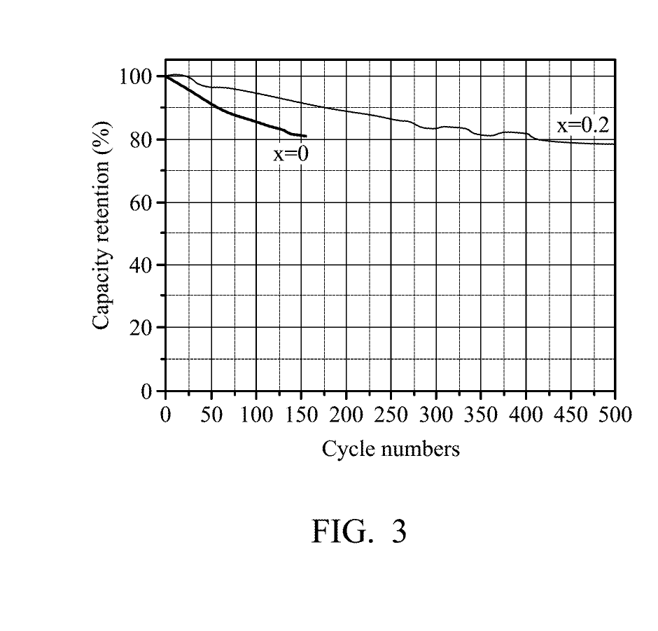

The negative electrode prepared in Example 1 was repetitively charged to 1.1V and then discharged to 0.7V by a current density of 500 mA/g, thereby measuring the capacity of the negative electrode at ambient temperature. As shown in FIG. 3, the negative electrode including the composite material Na₁₊₂ₓTi₂₋ₓMgₓ(PO₄)₃/C with x=0 had a capacity retention of about 80% after 150 charge-discharge cycle numbers. When x of the composite material Na₁₊₂ₓTi₂₋ₓMgₓ(PO₄)₃/C was increased from 0 to 0.2, the negative electrode had a similar capacity after 500 charge-discharge cycle numbers. In other words, the composite material with Mg may lengthen the charge-discharge cycle number of the negative electrode, e.g. 3 times the charge-discharge cycle life of the negative electrode having the composite material without Mg.

### Example 4

### Capacity Test of the Batteries with Sodium Manganese Oxide Positive Electrode

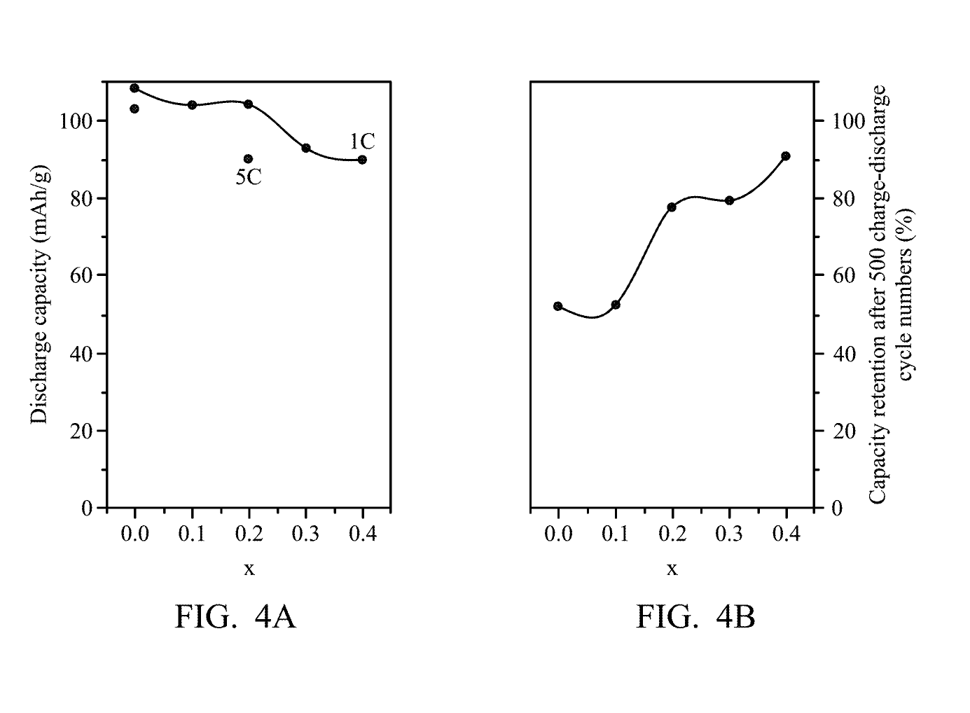

The sodium secondary battery in Example 1 was repetitively charged to 1.1V and then discharged to 0.7V by a current density of 100 mA/g to test its capacity. FIG. 4A shows discharge capacity curves of the batteries with the negative electrode including the composite material Na₁₊₂ₓTi₂₋ₓMgₓ(PO₄)₃/C discharged by the current density of 100 mA/g. When x of the composite material was increased from 0 to 0.2, the discharge capacity of the battery was decreased from 108 mAh/g to 104 mAh/g (no significant decay). When x of the composite material was 0.4, the discharge capacity of the battery was decreased to 90 mAh/g (about 17% decay). As shown in X-ray diffraction spectra of the composite materials Na₁₊₂ₓTi₂₋ₓMgₓ(PO₄)₃/C, the composite had an impurity phase when x≧0.3, and the impurity phase may result in the decay of the battery capacity. FIG. 4B shows capacity retention curves of the batteries with the negative electrode including the composite materials Na₁₊₂ₓTi₂₋ₓMgₓ(PO₄)₃/C (x=0˜0.4) after 500 charge-discharge cycle numbers. When x of the composite material Na₁₊₂ₓTi₂₋ₓMgₓ(PO₄)₃/C was increased from 0 to 0.2, the capacity retention of the battery was increased from 52% to 80%. When x of the composite material Na₁₊₂ₓTi₂₋ₓMgₓ(PO₄)₃/C was increased to 0.4, the capacity retention of the battery was 93%. The higher capacity retention may be caused by the sodium ion embedded crystalline lattice tunnel being broadened by the magnesium doping, and the increased ratio of the sodium ions. As such, the composite material structure is stabilized and free of the lattice damage from the embedded/escaped sodium ions, thereby greatly improving the cycle stability of the battery.

### Example 5

### Capacity Test of the Batteries with Sodium-Rich Metal Hexacyanoferrate Positive Electrode

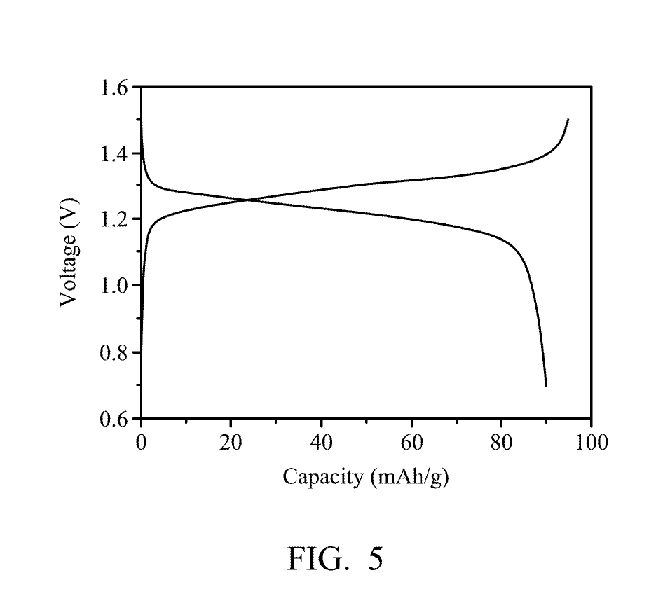

The steps in the experiment were similar to that in Example 4; a negative electrode including the composite material Na_{1.4}Ti_{1.8}Mg_{0.2}(PO₄)₃/C, the positive electrode of the sodium-rich metal hexacyanoferrate, and 1M sodium sulfate aqueous solution were assembled to a coin-type battery. The battery was charged to 1.5V and then discharged to 0.7V by a current density of 500 mA/g, thereby obtaining a charge-discharge curve of the battery as shown in FIG. 5. The discharge capacity of the battery was about 90 mAh/g. It has been proven that the negative electrode including the composite material of the disclosure can be collocated with other positive electrode material of suitable potential to manufacture a battery.

The disclosure may reduce the over potential of the composite material Na₁₊₍₄₋ₐ₎ₓTi₂₋ₓMₓ(PO₄)₃/C during the charge-discharge cycle by doping the metal element. In summary, the battery with the modified composite material in the negative electrode has an obviously stable cycle life and a high capacity retention.

It will be apparent to those skilled in the art that various modifications and variations can be made to the disclosed methods and materials. It is intended that the specification and examples be considered as exemplary only, with a true scope of the disclosure being indicated by the following claims and their equivalents.

What is claimed is:

1. A composite material, having the chemical formula:
Na₁₊₍₄₋ₐ₎ₓTi₂₋ₓMₓ(PO₄)₃/C,
wherein M is an element with valence a, a is a positive integer from 1 to 4, and 0.1≦x≦0.4.

2. The composite material as claimed in claim 1, wherein the sodium titanium metal phosphate has a Na⁺ superionic conductor structure.

3. The composite material as claimed in claim 1, wherein the sodium titanium metal phosphate content is 90 wt % to 97 wt %, and the carbon material content is 10 wt % to 3 wt %.

4. The composite material as claimed in claim 1, wherein M comprises magnesium, aluminum, vanadium, chromium, manganese, cobalt, nickel, copper, zinc, or a combination thereof.

5. A negative electrode, comprising:
a conductive layer on an electrically conductive substrate, wherein the electrically conductive layer includes:
1 part by weight of the composite material as claimed in claim 1;
0.055 to 0.33 parts by weight of a binder, and
0.055 to 0.33 parts by weight of an electrically conductive agent.

6. The negative electrode as claimed in claim 5, wherein the electrically conductive agent comprises carbon black, graphite, carbon nanotube, carbon nano fiber, or a combination thereof.

7. The negative electrode as claimed in claim 5, wherein the binder comprises poly(tetrafluoroethylene), poly(vinylidene fluoride), polyvinyl alcohol, carboxymethylcellulose, styrene-butadiene rubber, or a combination thereof.

8. The negative electrode as claimed in claim 5, wherein the electrically conductive substrate comprises metal foil, metal mesh, metal foam, or a combination thereof of stainless steel, aluminum, copper, or nickel.

9. A sodium secondary battery, comprising:
the negative electrode as claimed in claim 5;
a positive electrode;
a separator film disposed between the positive electrode and the negative electrode; and
an electrolyte disposed between the positive electrode and the negative electrode.

10. The sodium secondary battery as claimed in claim 9, wherein the positive electrode comprises sodium metal oxide (NaₓMO₂, M=Fe, Mn, Co, Ni, or a combination thereof, and 0<x≦1), sodium-rich metal hexacyanoferrate (Na₂MₓFe(CN)₆, M=Fe, Co, Ni, Cu, Zn, Mn, or a combination thereof, and 0<x≦1), sodium metal phosphate (Na₃M₂(PO₄)₃, M=Al or V), or a combination thereof.

11. The sodium secondary battery as claimed in claim 9, wherein the separator comprises glass fiber film, filter paper, polypropylene film, polyethylene film, or a combination thereof.

12. The sodium secondary battery as claimed in claim 9, wherein the electrolyte comprises an organic type electrolyte or an aqueous type electrolyte.

13. The sodium secondary battery as claimed in claim 12, wherein the aqueous type electrolyte comprises Na₂SO₄, NaCl, NaNO₃, or a combination thereof.
